(19) United States
(12) Patent Application Publication
(10) Pub. No.: US 2025/0371452 A1
(43) Pub. Date: Dec. 4, 2025

(54) AUTOMATED DISCOVERY OF ALTERNATE MANUFACTURING PATHWAYS

(71) Applicant: SRI International, Menlo Park, CA (US)

(72) Inventors: Tuhin Sahai, San Francisco, CA (US); Susmit Kumar Jha, Redwood City, CA (US); Manoj Acharya, Mountain View, CA (US)

(21) Appl. No.: 19/222,136

(22) Filed: May 29, 2025

Related U.S. Application Data
(60) Provisional application No. 63/654,740, filed on May 31, 2024.

(51) Int. Cl. G06Q 10/0631; G05B 19/418; G06F 16/901; G06Q 50/04

(52) U.S. Cl. CPC G06Q 10/06311; G05B 19/41865; G06F 16/9024; G06Q 50/04

(57) ABSTRACT

A computing system is configured to obtain a description of a first production process comprising first production steps. The computing system is further configured to apply a machine learning (ML) model to the description of the first production process to produce a first graph of the first production process comprising a first subgraph of first nodes. The computing system is further configured to identify a second graph of a second production process comprising a second subgraph of second nodes at least weakly isomorphic to the first subgraph, wherein each second node of the second nodes represents a corresponding second production step of second production steps of the second production process. The computing system is further configured to, based on the identified second graph, output an indication that equipment capable of performing the first production steps is capable of performing the second production steps of the second production process.

### RELATED APPLICATIONS

This application claims the benefit of U.S. Patent Application No. 63/654,740, filed 31 May 2024, the entire contents of which is incorporated herein by reference.

### GOVERNMENT RIGHTS

This invention was made with Government support under contract no. SP4701-24-C-0023 awarded by the Defense Logistics Agency (DLA). The Government has certain rights in this invention.

### TECHNICAL FIELD

This disclosure relates to analysis of manufacturing processes.

### BACKGROUND

Companies manufacture products that require various operations (e.g., manufacturing steps) as part of a manufacturing process to create a given product. For instance, a company may perform numerous manufacturing steps to manufacture an end product.

### SUMMARY

In general, this disclosure describes an analysis system configured to identify production and processing capabilities to enable identification of production steps of a second process that an entity, configured to perform production steps of a first process, is capable of performing. For example, an analysis system as described herein obtains information describing a first production process for producing products, articles, goods, etc. The analysis system also obtains information describing a plurality of different production processes. Using the techniques described herein, the analysis system identifies second production processes of the plurality of different production processes having one or more production steps in common with the first production process. The analysis system outputs an indication of the second production processes and information describing the one or more production steps shared with the first production process. Using this information, a manufacturer or producer of goods may repurpose a production site from producing first products or articles according to the first production process to producing second products or articles according to at least one of the second production processes while reusing the production steps common between the two processes, thereby minimizing the cost and time required for retooling or repurposing the production site to produce different products, articles, or goods. “Production steps,” as used herein, refer to individual steps or actions performed within an overarching process (e.g., pressure testing, milling, polishing, washing, welding, integrating a sub-component, shipping, etc.) to produce or manufacture a product or article. “Production processes,” as used herein, refer to the combination of manufacturing steps that result in an intermediate or final product, article, or good or the completion of a process (e.g., manufacturing a circuit board, distilling hydrocarbons into aviation fuel, chemical processes etc.).

Information describing production processes that include production steps may be obtained from a variety of sources. For example, the analysis system may crawl websites for information, ingest digital copies of reference materials (e.g., textbooks, manufacturing texts, etc.), and other sources. The analysis system may obtain information from an entity (e.g., a factory management system) and/or from domain experts regarding production steps used by the entity in production processes. The analysis system generates graphs using the obtained information for use in identifying alternate production steps.

The techniques of this disclosure provides one or more technical advantages that realize at least one practical application. For instance, the analysis system described herein may enable an entity to identify potential products that may be produced with minimal retooling or reconfiguring of production equipment, which may reduce operational expenses and cost incurred by a manufacturer or producer. Furthermore, the analysis system may enable an entity to identify alternative equipment. In another example, the analysis system may use graphs of manufacturing processes to identify similar manufacturing steps that a human analyst would be unable to identify due to the volume of potentially matching manufacturing processes, the complexity of production chains that may have numerous, interrelated steps of production that span international systems. In yet another example, the use of machine learning (ML) models trained on manufacturing information may enable the analysis system to identify manufacturing steps that are differently named or descripted but involve substantially the same operation.

In an example, a computing system includes storage media storing graphs of production processes and processing circuitry in communication with the storage media and configured to obtain a description of a first production process comprising first production steps; apply a machine learning (ML) model to the description of the first production process to produce a first graph of the first production process comprising a first subgraph of first nodes, wherein each first node of the first nodes represents a corresponding first production step of the first production steps; identify, from the storage media, a second graph of a second production process comprising a second subgraph of second nodes isomorphic to the first subgraph, wherein each second node of the second nodes represents a corresponding second production step of second production steps of the second production process; and based on the identified second graph, output an indication that equipment, parts, suppliers, or any combination thereof capable of performing the first production steps is capable of performing the second production steps of the second production process.

In another example, a method includes obtaining, by processing circuitry of a computing system, a description of a first production process comprising first production steps; applying, by the processing circuitry, a machine learning (ML) model to the description of the first production process to produce a first graph of the first production process comprising a first subgraph of first nodes, wherein each first node of the first nodes represents a corresponding first production step of the first production steps; identifying, by the processing circuitry, from a datastore of graphs of production processes, a second graph of a second production process comprising a second subgraph of second nodes isomorphic to the first subgraph, wherein each second node of the second nodes represents a corresponding second production step of second production steps of the second production process; and based on the identified second graph, outputting, by the processing circuitry, an indication that equipment, parts, suppliers, or any combination thereof capable of performing the first production steps is capable of performing the second production steps of the second production process.

In yet another example, non-transitory computer-readable media comprises instructions that, when executed by processing circuitry, causes the processing circuitry to obtain a description of a first production process comprising first production steps; apply a machine learning (ML) model to the description of the first production process to produce a first graph of the first production process comprising a first subgraph of first nodes, wherein each first node of the first nodes represents a corresponding first production step of the first production steps; identify, from the storage media, a second graph of a second production process comprising a second subgraph of second nodes isomorphic to the first subgraph, wherein each second node of the second nodes represents a corresponding second production step of second production steps of the second production process; and based on the identified second graph, output an indication that equipment, parts, suppliers, or any combination thereof capable of performing the first production steps is capable of performing the second production steps of the second production process.

In another example, a method includes obtaining, by processing circuitry of a computing system, a first input comprising descriptions in one or more modalities of production processes and corresponding graphs of the production processes; training, by the processing circuitry, a machine learning (ML) model with the descriptions of the production processes and the corresponding graphs of the production processes to generate, from a second input comprising a natural language description of a second production process, a second graph of the second production process; and storing, by the processing circuitry, the second graph of the second production process in a datastore.

In yet another example of the techniques, a computing system includes storage media and processing circuitry in communication with the storage media and configured to obtain a first input comprising descriptions in one or more modalities of production processes and corresponding graphs of the production processes, train a machine learning (ML) model with the descriptions of the production processes and the corresponding graphs of the production processes to generate, from a second input comprising a natural language description of a second production process, a second graph of the second production process; and store the second graph of the second production process in a datastore.

In another example, non-transitory computer-readable media comprises instructions that, when executed by processing circuitry, causes the processing circuitry to obtain a first input comprising descriptions in one or more modalities of production processes and corresponding graphs of the production processes, train a machine learning (ML) model with the descriptions of the production processes and the corresponding graphs of the production processes to generate, from a second input comprising a natural language description of a second production process, a second graph of the second production process; and store the second graph of the second production process in a datastore.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example computing environment that includes a computing system for identifying alternate production processes, in accordance with techniques of the disclosure.

FIG. 2 is a block diagram illustrating an example analysis system for identifying alternate production processes, in accordance with techniques of the disclosure.

FIG. 3 is a block diagram illustrating an example computing environment for identifying alternate production processes, in accordance with the techniques of this disclosure.

FIG. 4 is an example set of production processes, in accordance with techniques of the disclosure.

FIG. 5 is an example configuration of an analysis system, in accordance with techniques of the disclosure.

FIG. 6 is a flowchart illustrating an example operation to identify alternate production processes, in accordance with the techniques of this disclosure.

FIG. 7 is a flowchart illustrated an example operation to train a machine learning model, in accordance with the techniques of this disclosure.

Like reference characters refer to like elements throughout the figures and description.

### DETAILED DESCRIPTION

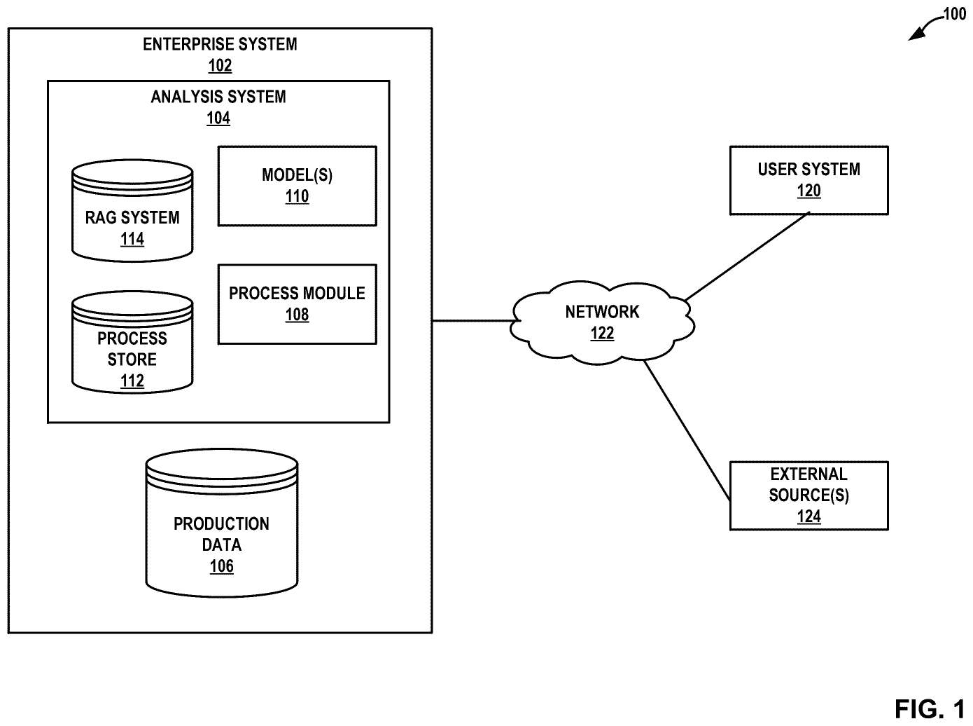

FIG. 1 is a block diagram illustrating an example computing environment 100 that includes a computing system for identifying alternate production processes, in accordance with the techniques of this disclosure.

Computing environment 100 includes enterprise system 102, which may be a computing system associated with an enterprise, such as a server, mainframe, supercomputer, cloud computing environment, distributed computing environment, virtualized computing environment, desktop computer, laptop computer, tablet computer, smartphone, or other type of computing device. An enterprise may manage and configure enterprise system 102 to perform one or more tasks, such as controlling manufacturing equipment, storing information regarding the enterprise and production processes, enabling user control and configuration of production processes and/or functions of the enterprise. The enterprise may include one or more types of organizations or entities, such as manufacturing companies, chemical companies, factories, laboratories, research facilities, government entities, and/or other types of organizations. In an example, a chemical company configures enterprise system 102 to manage the production of chemicals produced at a facility.

Enterprise system 102 includes production data 106, which may be a datastore of information related to the enterprise and/or production processes. Enterprise system 102 may store and retrieve information from production data 106, such as information regarding production processes used by the enterprise in producing various products. For example, enterprise system 102 may store information regarding a manufacturing a product in production data 106.

Computing environment 100 includes network 122, which may include one or more types of networks that interconnect enterprise system 102 and other computing devices/systems. Network 122 may include local network, the Internet, and/or other types of networks that connect user system 120 and external sources 124 with enterprise system 102. For example, network 122 may include a local network that communicatively connects enterprise system 102 and user system 120.

User system 120 may include one or more types of computing devices associated with users, such as servers, laptops, desktops, tablet computers, augmented reality/virtual reality glasses/goggles, artificial intelligence (AI)-enabled devices and/or peripherals, thin clients, virtual machines, and/or other types of computing devices. In some examples, user system 120 may be located on-site with enterprise system 102. User system 120 may enable a user to interact with enterprise system 102 and perform one or more actions. For example, user system 120 may enable a user to interact with enterprise system 102 to reconfigure equipment used by the enterprise as part of production processes.

An enterprise, such as the enterprise of computing environment 100, may find it beneficial to identify other uses for equipment used for production processes. For instance, an enterprise may find it beneficial to diversify the types of products produced by the enterprise without requiring substantial capital expenditures to reconfigure production processes with different equipment and instead repurpose equipment to produce different products. In addition, government organizations may find it beneficial to understand supply chains and production capacity. However, the enterprise may find it challenging to identify such other uses due to the innate complexity of supply chains and production processes. For instance, two production processes may be similar in operation but known by different names in different industries. Furthermore, a human operator may be unable to identify alternate production processes due to the sheer complexity of production processes across industries and different naming conventions different industries may have for the same processes, intermediate components, or articles, etc.

In accordance with the techniques described herein, a computing system, such as analysis system 104, identifies production and processing capabilities to enable identification of production steps of a second process (e.g., “alternate” production steps) that an entity, configured to perform production steps of a first process, is capable of performing. The computing system obtains a description of a first production process and applies a machine learning model to product a first graph of the first production process. The computing system identifies a subgraph that is isomorphic to a subgraph of the first production process. The computing system outputs an indication that equipment capable of performing production steps of the first production process is capable of performing of performing second production steps corresponding to nodes of the identified subgraph.

Computing environment 100 includes analysis system 104, which may be a computing system configured to identify alternate production steps. Analysis system 104 may include one or more types of computing systems, such as servers, mainframes, virtual machines, cloud services, desktops, laptops, tablet computers, and/or other types of computing systems or virtualized computing environments. As illustrated in FIG. 1, analysis system 104 may be embedded or otherwise included in another computing system of an enterprise, such as enterprise system 102. In some examples, analysis system 104 may be configured as a separate computing system, such as a system external to enterprise system 102 and connected via network 122.

Analysis system 104 includes process store 112, which may be a datastore or other type of data structure that includes information regarding production processes. Analysis system 104 may obtain data from a plurality of sources for inclusion in process store 112 and process the obtained data. Analysis system 104 may store the information regarding production processes in natural language in process store 112 as graphs or other structures with multiple nodes and with each production step of the production processes related to other processes in an associated production process and as related to other production processes from other production processes that meet a threshold level of similarity. In an example, analysis system 104 obtains data regarding production processes from a reference datastore. Analysis system 104 processes the data regarding production processes into graphs with natural language nodes for each of the production processes (e.g., with each node including a natural language description of an associated production step). As part of processing the data, analysis system 104 may interrelates or associate nodes between the graphs within process store 112. Analysis system 104 may store information in process store 112 as graphs with interrelated nodes in natural language and generate retrieval augment generation (RAG) system 114 based on data stored in process store 112. In some examples, RAG system 114 incorporates process store 112 into a combined component of analysis system 104.

In some examples, analysis system 104 may obtain information from external sources 124. Computing environment 100 includes external sources 124, which may include one or more computing systems configured to store information. External sources 134 may store information that includes electronic copies of textbooks, other documents, spreadsheets, reports, datastores, repositories of production process information from other entities, websites, and/or other information. In some examples, external sources 134 may include a central repository of production processes for use by analysis system 104. Analysis system 104 may obtain information from external sources 124 in one or more ways, such as requesting information from external sources 124, receiving updates pushed by external sources 124, scraping information from websites included in external sources 124, and/or other information. In an example, analysis system 104 scrapes information from a website regarding a particular production process. Analysis system 104 stores the scraped information in process store 112 for further processing and inclusion in RAG system 114.

Analysis system 104 includes RAG system 114, which may be a datastore configured to store graphs of production processes. RAG system 114 may store graphs that are graphs of productions processes with each production step of a corresponding production process represented by a representation, where the representation includes one or more of vectors, embeddings, matrices, and/or tensors. For example, analysis system 104 may store a graph of a production process where each node of the graph is a representation corresponding to a production step within an n-dimensional space of RAG system 114. In some examples, RAG system 114 may include a contextual datastore that includes the graphs of production processes.

Analysis system 104 may generate the graphs stored in RAG system 114 using one or more of models 110. Analysis system 104 may apply models 110 to the data of process store 112 to generate the graphs included in RAG system 114. For example, analysis system 104 may apply models 110 to generate representations representing production steps of production processes, with each representation associated with representations other production steps (e.g., a first representation associated with a second representation of the same production process, a first representation associated with a second representation where both representations represent similar production steps from different production processes, etc.).

Analysis system 104 obtains a description of a production process. Analysis system 104 may obtain a description generated by user system 120 in response to a user query or request to identify alternate production processes among those stored in process store 112 and/or contextual data 114. Analysis system 104 may obtain descriptions of production processes (e.g., production processes implemented by the entity) and indications to identify alternate production processes from user system 120. In an example, analysis system 104 receives a query from user system 120 that includes a natural language description of a production process. Analysis system 104 provides data regarding the query to process module 108 for process module 108 to process the query. In some examples, analysis system 104 may obtain the description of the production process from other sources, such as production data 106 or from an input component of analysis system 104.

Analysis system 104 includes process module 108, which may be a software component of analysis system 102 that is configured to identify production steps of a second process that an entity, configured to perform production steps of a first process, is capable of performing. Process module 108 may orchestrate the functionality of other components of analysis system 104 as part of identifying alternate production processes. For instance, process module 108 may cause one or more components of analysis system 104 to identify alternate production processes using data stored by analysis system 104.

Process module 108 may apply one or more of models 110 to the description of the production process. Models 110 may include one or more types of machine learning (ML) models, such as language modules (e.g., large language models or “LLMs”), neural networks, embedding models, deep-learning models, Q-learning models, recursive networks, and/or other types of ML models. Process module 108 may apply one of models 110 to the description of the production process to produce a first graph of the production process that includes one or more subgraphs where each node of the graph corresponds to a production step of the production process. In an example, process module 108 obtains a description of a production process. Process module 108 provides the description to an embedding model as input. The embedding model processes the description and produces a first graph of the production process, where each node of the first graph corresponds to a production step of the production process. Process module 108 may apply models 110 to produce graphs that include one or more subgraphs, where the subgraphs are logical subsets of a given graph. For example, models 110 may produce graph of a production process that includes subgraphs corresponding to subsets of the production process.

Process module 108 may identify one or more subgraphs in RAG system 114 that are isomorphic to a first subgraph of the graph of the obtained description. Process module 108 may use one or more techniques and/or optimizer algorithms to identify a subgraphs that are isomorphic to a subgraph of the graph of the obtained description, such as applying a genetic algorithm, simulated annealing, Monte Carlo tree search, tree search, and/or other techniques/algorithms. Process module 108 may identify the isomorphic subgraphs by determining whether a first graph contains a subgraph that is at least weakly isomorphic to a second graph, where the isomorphism is representative of a first graph including a same structure as a second graph irrespective of the atomic components of the graphs. In an example, process module 108 obtains a first graph produced by models 110, where the first graph is a graph of an obtained description of a production process. Process module 108 applies an optimizer algorithm to the first graph and the graphs included in RAG system 114. Process module 108 identifies a second graph that includes a second subgraph isomorphic to a first subgraph of the first graph. While described in the context of isomorphism, this may also be referred to herein as a “similar” portion of a graph, or that the portions of the graphs are the “same” or “equivalent.” Other techniques, not expressly described herein, for determining that portions of two graphs are the same or similar may also be used in accordance with the techniques of the disclosure.

Analysis system 104 outputs an indication that that equipment capable of performing the first production steps is capable of performing the second production steps of the second production process based on the identified second graph. Analysis system 104 may output an indication via one or more output components of analysis system 104 and/or output the indication to user system 120 in response to the identification of the second subgraph. For example, analysis system 104 may generate an indication that equipment is capable of performing the second production steps and provide the indication to user system 120 for user system 120 to output to a user. In some examples, analysis system 104 processes one or more graphs into natural language as part of outputting the indication.

The techniques of this disclosure provides one or more technical advantages that realize at least one practical application. For instance, analysis system 104 may enable an entity to identify potential products that may be produced with minimal retooling or reconfiguring of production equipment, which may reduce operational expenses and cost incurred by a manufacturer or producer. In another example, analysis system 104 may use graphs of manufacturing processes to identify similar manufacturing steps that a human analyst would be unable to identify due to the volume of potentially matching manufacturing processes, the complexity of production chains that may have numerous, interrelated steps of production that span international systems. In yet another example, the use of models 110 trained on manufacturing information may enable analysis system 104 to identify manufacturing steps that are differently named or descripted but involve substantially the same operation.

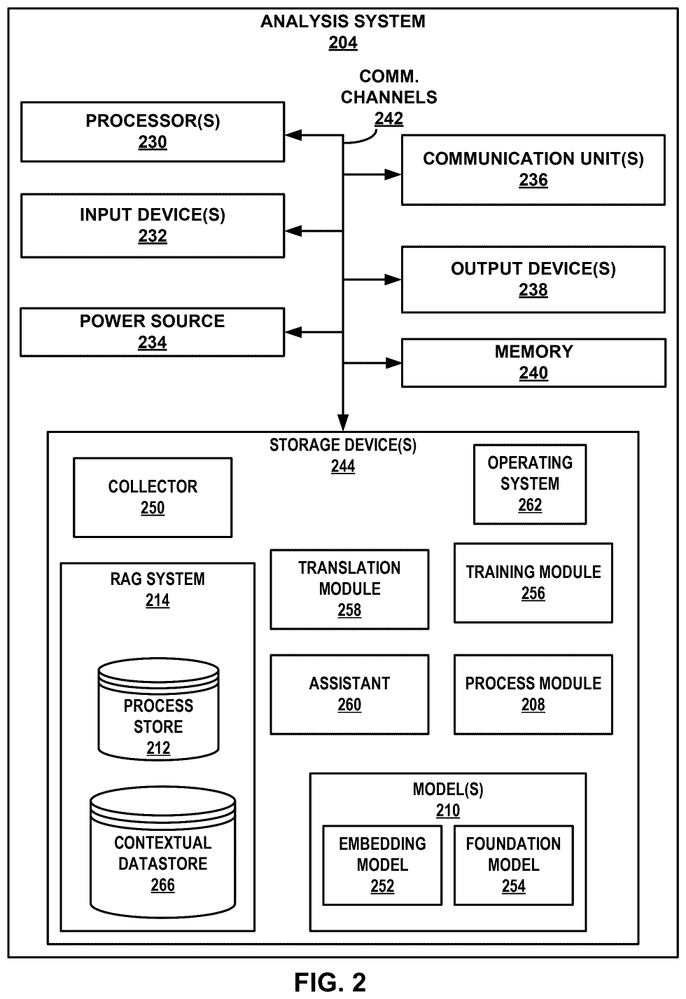

FIG. 2 is a block diagram illustrating an example analysis system 204 for identifying alternate production processes, in accordance with techniques of the disclosure. Analysis system 204 may be an example instance of analysis system 102 of FIG. 1.

Analysis system 204 includes one or more of processors 230 which may include one or more types of processors. For example, processors 230 may include one or more of FPGAs, ASICs, graphics processing units (GPUs), central processing units (CPUs), reduced instruction set (RISC) processors, and/or other types of processors or processing circuitry. Processors 230 may execute the instructions of one or more programs and/or processes of analysis system 204. For example, processors 230 may execute instructions of a process stored in memory 240.

Analysis system 204 includes memory 240. Memory 240 may include one or more types of volatile data storage such as random access memories (RAM), dynamic random access memories (DRAM), static random access memories (SRAM), and other forms of volatile memories known in the art. Memory 240 may additionally or alternatively include one or more types of non-volatile data storage. Memory 240 may store data, such as instructions for one or more processes of analysis system 204. For example, memory 240 may store instructions of an operating system for execution by processors 230. Memory 240 may store data provided by one or more components of analysis system 204. For example, memory 240 may store information provided by communication units 236.

Analysis system 204 includes one or more of communication units 236, which may include one or more types of communication units/components such radios, modems, transceivers, ports, and/or other types of communication components. Communication units 236 may communicate using one or more communication protocols such as WIFI, BLUETOOTH, cellular communication protocols, satellite communication protocols, Asynchronous Transfer mode (ATM), ETHERNET, TCP/IP, optical network protocols such as Synchronous Optical Networking (SONET) and Synchronous Digital Hierarchy (SDH), and other types of communication protocols. Communication units 236 may enable analysis system 204 to communicate with one or more computing systems and devices. For example, communication units may enable analysis system 204 to communicate with a user system such as user system 120 as illustrated in FIG. 1.

Analysis system 204 includes one or more of input devices 232. Input devices 232 may include one or more devices and/or components capable of receiving input such as touchscreens, microphones, keyboards, mice, and other types of input devices. Input devices 232 may enable a user of analysis system 204 to provide input to analysis system 204. For example, input devices 232 may enable a user of analysis system 204 to type input via a keyboard.

Analysis system 204 includes one or more of output devices 238. Output devices 238 may include one or more devices and/or components capable of generating output such as displays, speakers, haptic engines, light indicators, and other types of output devices. Output devices 238 may enable analysis system 204 to provide output to a user of analysis system 204. For example, analysis system 202 may provide output of results of a query for alternate production processes.

Analysis system 204 includes power source 234. Power source 234 may include one or more sources of power for analysis system 204 such as solar power, battery backup, generator backup, and power from an electrical grid. For example, analysis system 204 may be powered by power source 234 that includes a connection to an electrical grid and a generator backup.

Analysis system 204 includes one or more of communication channels 242 (illustrated as “COMM. CHANNELS 242” in FIG. 2). Communication channels 242 may include one or more communication channels that interconnect one or more components of analysis system 204. Communication channels 242 may include one or more types of communication channels such as hardware interconnects and/or software interconnects, networks, busses, or other types of channels. For example, communication channels 242 may include a hardware interconnect between memory 240 and storage devices 244.

Analysis system 204 includes one or more of storage devices 244. Storage devices 244 may include one or more devices and/or components capable of storing data. Storage devices 244 may include one or more types of non-volatile storage devices such as magnetic hard drives, magnetic tape drives, solid state drives, NVM Express (NVMe) drives, optical media, and other types of non-volatile storage. In some examples, storage devices 244 may include one or more types of volatile storage devices. Storage devices 244 may include one or more databases which may be integrated within the one or more storage components of storage devices 244 and/or external to and communicatively coupled with analysis system 204 (e.g., such that analysis system 204 may read and write to the databases).

Storage devices 244 may store information of one or more software components of analysis system 202 such as operating system 262 (hereinafter “OS 262”). OS 262 may be an operating system (OS) of analysis system 204 that provides an execution environment for one or more programs and/or processes of analysis system 204. For example, OS 262 may provide an execution environment for process module 208.

Storage devices 244 include process module 208, which may be an instance of process module 108 as illustrated in FIG. 1. Process module 208 may orchestrate the functions of one or more components of analysis system 204. For example, process module 208 may orchestrate the identification of alternate production steps in response to a query requesting the identification of alternate production steps.

Storage devices 244 include models 210, which may be instances of models 110 as illustrated in FIG. 1. Models 210 may include one or more types of ML models trained to perform one or more types of functions for analysis system 204. While illustrated as including embedding model 252 and foundation model 254 in FIG. 2, models 210 may include one or more other ML models. Embedding model 252 may be an ML model trained to convert natural language descriptions of production processes into graph that include representations (e.g., vectors, embeddings, matrices, tensors, etc.) of production steps of the production processes. Foundation model 254 may be language model trained to process graphs into natural language (e.g., the results of identifying alternate production steps).

Storage devices 244 include training module 256, which may be a software component of analysis system 204 configured to train models 210. Training module 256 may train models 210 in one or more ways, such as by generating question and answer pairs regarding production processes and modifying weights of models 210 a based on output by a model to questions provided as input. In an example

Storage devices 244 include process store 212, which may be an instance of process store 112 as illustrated in FIG. 1. For instance, process store 212 may store natural language descriptions of production process organized in one or more ways, such as graphs with individual production steps as nodes. Process store 212 may store information regarding relationships and similarities between production processes and/or similarities. For example, analysis system 204 may store information regarding battery assembly being related to the assembly of cellphones and the assembly of electric vehicles. While illustrated as within RAG system 214, contextual datastore 266 may operate as a component of analysis system 204 that is separate from RAG system 214 in some examples.

Storage devices 244 include RAG system 214, which may be an instance of RAG system 114 as illustrated in FIG. 1. RAG system 214 may include information regarding production processes organized in one or more forms, such as graphs, spreadsheets, and/or other types of data structures. Analysis system 204 may process the information regarding production processes to adhere to a modeling language or other normalized format. For example, analysis system 204 may process the description of a given production process to organize the description in accordance with the modeling language and store the processed description in contextual datastore.

In some examples, RAG system 214 includes contextual datastore 266, which may be a software component included in storage devices 244. contextual datastore 266 may include information that enables analysis system 204 to implement RAG using RAG system 214 and improve the accuracy of outputs of models 210. RAG system 214 may retrieve information from contextual datastore for use by models 210 when generating response to enable models 210 to incorporate the latest information added to RAG system 214 and to provide guardrails for the outputs of models 210. In an example, process module 209 provides a prompt to models 210 regarding a particular production process. RAG system 214 uses contextual datastore 266 to retrieve graphs from RAG system 214 and provides the graphs to models 210 for models 210 to identify alternate production steps. In some examples, RAG system 214 may modify a prompt from process module 208 for models 210 to encourages the models to prioritize information in contextual datastore 266 over training knowledge. Analysis system 204 may instantiate a knowledge base in the form of information in the Retrieval Augmented Generation (RAG) system that is curated by information from public and private sources and subject matter experts. Analysis system 204 may store multi-modal information in the form of text, videos, graphs of manufacturing processes/work breakdown structures/bill of materials, information from dynamic knowledge base is created by the AI model by processing large amounts of manufacturing data and generating semantic similarity across manufacturing domains. The domain specific foundation model also generates outputs that supplement the knowledge base.

In some examples, Existing Retrieval Augmented Generation (RAG) systems may work with data samples and examples but may be unable to retrieve and ingest symbolic knowledge that arises in supply chains, drug discovery, manufacturing processes, health assistants, and automated scientific discovery. Analysis system 204 may define a new approach for defining a Domain Specific Language (DSL) to ingest symbolic knowledge and develop novel chunking, similarity metric, ranking function, and prompt ordering methods to find relevant knowledge in addition to data samples for RAG. Analysis system 204 may define the DSL as a the domain specific language that is a language based on an ontology that is associated with the domain (in this case manufacturing or production processes). Analysis system 204 may use data on production processes (descriptions and diagrams) to train a foundation model that is capable of generating the process flow diagrams, bill of materials, material breakdown structures that are described in the domain specific language.

In some examples, RAG system 214 determines distances between nodes of contextual datastore 214 266/or nodes of a description obtained by analysis system 204. RAG system 214 may determine distances between nodes of contextual datastore 214 where the distances are representative of similarity between production processes. For example, RAG system 214 may determine that two nodes that both describe testing a tank for leakage are comparatively closer in the n-dimensional space of contextual datastore 214 than a first node that describes testing a tank for leakage and a second node that describes processing lithium carbonate. RAG system 214 may store information regarding the distances between nodes in contextual datastore 214 for use by process module 208 and/or models 210.

In some examples, analysis system 204 may determine scores representative of distances between nodes within contextual datastore 266. Analysis system 204 may determine a plurality of scores where each score of the plurality of scores is representative of a distance between first nodes of a first graph and second nodes of a second graph, a distance between a description of a first edge between the first nodes of the first graph and a description of a second edge between the second nodes of the second graph, and/or both. Analysis system 204 may determine whether each score of the plurality of scores satisfies a predetermined threshold. For example, analysis system 204 may use whether a score satisfies a predetermined threshold to determine whether a node of a first subgraph is sufficiently close to a node of a second subgraph.

Storage devices 244 include collector 250, which may be a software component of analysis system 204 configured to obtain information regarding production processes. Collector 250 may obtain the information regarding production processes in one or more ways, such as requesting information from datastores internal and/or external to an entity (e.g., external sources 124 as illustrated in FIG. 1), scraping websites or other sources, and/or other ways of obtaining information. In some examples, collector 250 may obtain information regarding production processes from a central repository of production processes. Collector 250 may store the information regarding production processes in process store 214. In some examples, collector 250 may pre-process the information or provide the information to another component of analysis system 204 for processing (e.g., such as into natural language graphs of production processes). Collector 250 may obtain graphs from a human (e.g., a subject matter expert or other individual). For example, collector 250 may obtain a graph regarding a particular production process that includes nodes representative of production steps from a human.

Analysis system 204 includes translation module 258, which may be a software component of analysis system 204 that is configured to process information regarding production processes into other forms. Translation module 258 may process information in one or more ways, such processing descriptions of production processes to adhere to a modeling language. Translation module 258 may use a modeling language that is a domain specific language (DSL) specific to a production process domain when processing information regarding production processes/steps to reduce the complexity and difficulty of identifying alternate production steps. Translation module 258 may use the modeling language to normalize descriptions of production processes/steps into a format consistent with the modeling language. In an example, translation module 258 receives a description of a production process that includes production steps. Translation module 258 processes the description of the production process and generates statements based on the description of the production process that adhere to the modeling language (e.g., a statement corresponding to each production step of the production process). Translation module 258 provides the statements to embedding model 258 for embedding model 252 to vectorize each of the statements into nodes for RAG system 214. Translation module 258 updates RAG system 214 with the vectorized statements.

Storage devices 244 include assistant 260, which may be a software component of analysis system 204 configured to output information regarding alternate production processes. In some examples, the functionality of assistant 260 may be implemented by process module 208 and/or other components of analysis system 204. Assistant 260 may process the output of models 210 and/or other components and generate one or more types of output to a user, such as recommendations to swap production processes/steps, information about the production processes of an entity (e.g., types of products the entity may produce), and/or other output. For example, assistant 260 may obtain output from foundation model 254 and process the output into a recommendation to swap production steps and produce a different product. Assistant 260 may output the recommendation as including a recommendation to configure equipment to perform the second production steps.

In some examples, assistant 260 may output a report that includes an indication of a potential product. Analysis system 204 may determine a potential production of a second production process based on the identification of a second graph representative of the second production process. For example, analysis system 204 may determine a potential product that may be produced by equipment used for a production process included in a query and generate a report that includes an indication of the potential product.

In accordance with the techniques described herein, a computing system, such as analysis system 204, identifies production and processing capabilities to enable identification of alternate production steps or production steps of a second process that an entity, configured to perform production steps of a first process, is capable of performing. The computing system obtains a description of a first production process and applies a machine learning model to product a first graph of the first production process. The computing system identifies a subgraph that is at least weakly isomorphic to a subgraph of the first production process. In some examples, the computing system identifies a subgraph that is strongly isomorphic to a the subgraph of the first production process. The computing system outputs an indication that equipment capable of performing production steps of the first production process is capable of performing of performing second production steps corresponding to nodes of the identified subgraph.

Analysis system 204 obtains a description of a production process. Analysis system 204 may obtain a description generated by a user system, such as user system 120 as illustrated in FIG. 1, in response to a user query or request to identify alternate production processes among those stored in process store 212 and/or contextual data 214. Analysis system 204 may obtain descriptions of production processes (e.g., production processes implemented by the entity) and indications to identify alternate production processes from user system 120. In an example, analysis system 204 receives a query from user system 120 that includes a natural language description of a production process. Analysis system 204 provides data regarding the query to process module 208 for process module 208 to process the query. In some examples, analysis system 204 may obtain the description of the production process from other sources, such as production data 106 as illustrated in FIG. 1 or from an input component of analysis system 204.

In some examples, analysis system 204 may receive a query that includes specific information about the production process of interest. For example, analysis system 204 may receive a user query from a user that includes “manufacturing steps for cathode production in Li-ion batteries”. Process store 212 includes information about all areas of production. Analysis system 204 may filter the RAG system 214 for the areas relevant for cathode production in Li-ion batteries.

Process module 208 may apply one or more of models 210 to the description of the production process. Models 210 may include one or more types of machine learning (ML) models, such as language modules (e.g., large language models or “LLMs”), neural networks, embedding models, deep-learning models, Q-learning models, recursive networks, and/or other types of ML models. Process module 208 may apply one of models 210 to the description of the production process to produce a first graph of the production process that includes one or more subgraphs where each node of the graph corresponds to a production step of the production process. In an example, process module 208 obtains a description of a production process. Process module 208 provides the description to embedding model 252 as input. Embedding model 252 processes the description and produces a first graph of the production process, where each node of the first graph corresponds to a production step of the production process. Process module 208 may apply models 210 to produce graphs that include one or more subgraphs, where the subgraphs are logical subsets of a given graph. For example, models 210 may produce graph of a production process that includes subgraphs corresponding to subsets of the production process. In an example, analysis system 204 obtains information regarding the production processes and generates a corresponding graph of the graphs from the datastore, wherein to generate the corresponding graph. Analysis system 204 parses one or more second manufacturing steps from the second manufacturing processes and vectorizes the one or more second manufacturing steps into a node of the RAG database

Process module 208 may identify one or more subgraphs in RAG system 214 that are isomorphic to a first subgraph of the graph of the obtained description. Process module 208 may use one or more techniques and/or optimizer algorithms to identify a subgraphs that are at least weakly isomorphic to a subgraph of the graph of the obtained description, such as applying a genetic algorithm, simulated annealing, Monte Carlo tree search, tree search, and/or other techniques/algorithms. Process module 208 may identify a weakly isomorphic subgraph, where the weak isomorphism is based on maximizing a score that is generated by matching nodes and edges. In strongly isomorphic cases, the matches across nodes and edges are exact. For “weak” overlapping of graphs/edges, process module 208 determines matches by scoring the graphs between 0 and 1. Process module 208 then maximizes these scores. Process module 208 may identify the weakly isomorphic subgraphs by determining whether a first graph contains a subgraph that is isomorphic to a second graph, where the isomorphism is representative of a first graph including a same structure as a second graph irrespective of the atomic components of the graphs. Process module 208 may apply an optimizer algorithm to determine the distance between representations of subgraphs within the first graph and representations of subgraphs within the second graph associated between each of the representations representative of the production steps within the production process and one or more representations representative of production processes included in the plurality of graphs of the RAG database. In an example, process module 208 obtains a first graph produced by models 210, where the first graph is a graph of an obtained description of a production process. Process module 208 applies an optimizer algorithm to the first graph and the graphs included in RAG system 214. Process module 208 identifies a second graph that includes a second subgraph isomorphic to a first subgraph of the first graph. While described in the context of isomorphism, this may also be referred to herein as a “similar” portion of a graph, or that the portions of the graphs are the “same” or “equivalent.” Other techniques, not expressly described herein, for determining that portions of two graphs are the same or similar may also be used in accordance with the techniques of the disclosure. For instance, process module 208 may apply one or more types of optimizer algorithms that include a genetic algorithm, simulated annealing, Monte Carlo tree search, and/or a tree search.

Analysis system 204 outputs an indication that that equipment capable of performing the first production steps is capable of performing the second production steps of the second production process based on the identified second graph. Analysis system 204 may output an indication via one or more output components of analysis system 204 and/or output the indication to user system 120 in response to the identification of the second subgraph. For example, analysis system 204 may generate an indication that equipment is capable of performing the second production steps and provide the indication to user system 120 for user system 120 to output to a user. In some examples, analysis system 204 processes one or more graphs into natural language as part of outputting the indication.

The techniques of this disclosure provides one or more technical advantages that realize at least one practical application. For instance, analysis system 204 may enable an entity to identify potential products that may be produced with minimal retooling or reconfiguring of production equipment, which may reduce operational expenses and cost incurred by a manufacturer or producer. In another example, analysis system 104 may use graphs of manufacturing processes to identify similar manufacturing steps that a human analyst would be unable to identify due to the volume of potentially matching manufacturing processes, the complexity of production chains that may have numerous, interrelated steps of production that span international systems. In yet another example, the use of models 210 trained on manufacturing information may enable analysis system 204 to identify manufacturing steps that are differently named or descripted but involve substantially the same operation.

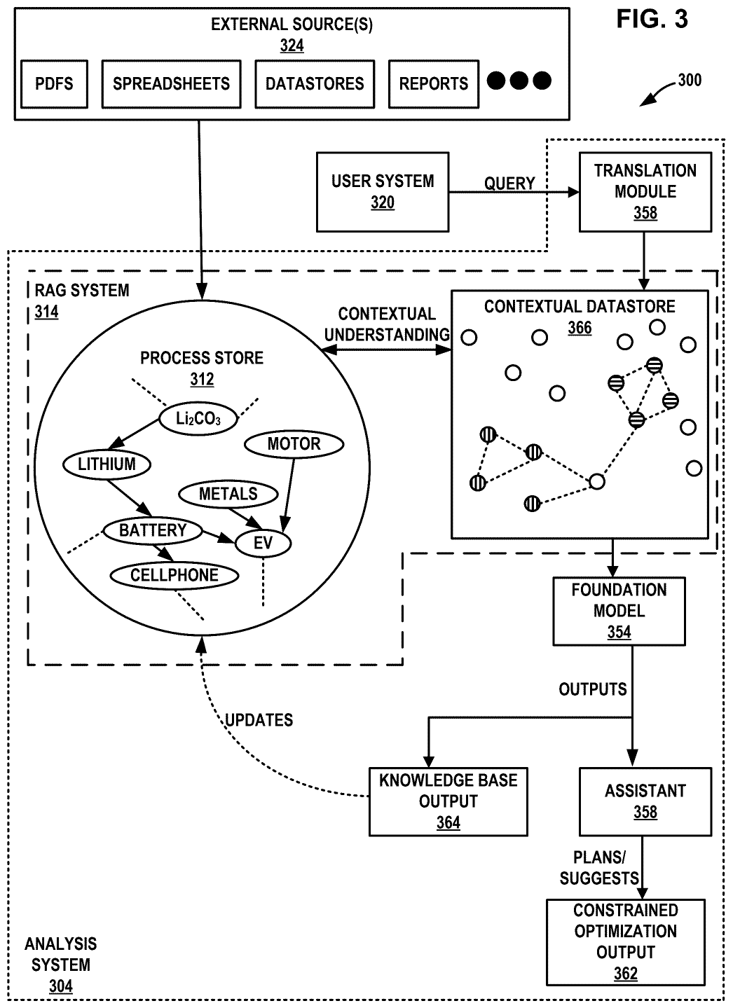

FIG. 3 is a block diagram illustrating an example computing environment 300 for identifying alternate production processes, in accordance with the techniques of this disclosure. Computing environment 300 may be an instance of computing 100 as illustrated in FIG. 1 and provide similar functionality.

Computing environment 300 includes user system 320, which may be an instance of user system 120 as illustrated in FIG. 1. User system 320 may generate queries requesting the determination of alternate production processes and other information for analysis system 304. In an example, user system 320 receives user input consistent with a user requesting the identification of alternate production processes for a production line of a factory. User system 320 generates a query based on the user input and provides the query to translation module 258. User system 320 may generate queries that include various types of information, such as text, images, and other information.

Computing environment 300 includes analysis system 304, which may be a computing system configured to identify alternate production processes. Analysis system 304 may execute as a standalone system or within another computing system (e.g., enterprise system 102 as illustrated in FIG. 1) and execute on-premises of an organization or remotely (e.g., as a cloud system). Analysis system 304 may process user queries and identify alternate production processes using one or more components, such as translation module 358. In some examples, analysis system 304 may implement one or more components as part of a multi-agentic architecture. For example, one or more AI agents may provide the functionality of each of the components of analysis system 304 for each modality of a plurality of different modalities of data describing one or more production processes. As an example, one or more first AI agents may provide the functionality of each of the components of analysis system 304 for processing visual data, such as images or video, one or more second AI agents may provide the functionality of each of the components of analysis system 304 for processing textual data, such as documents or manuals, one or more third AI agents may provide the functionality of each of the components of analysis system 304 for processing graph data, and/or one or more fourth AI agents may provide the functionality of each of the components of analysis system 304 for processing audio data, such as recordings or narrations.

Analysis system 304 includes translation module 358, which may be a software component of analysis system 304 configured to process queries to analysis system 304. Translation module 358 may process queries by translating the contents of the queries into queries whose contents are formatting in accordance with a modeling language, such as the DSL specific to a production process domain. Translation module 258 may use a DSL configured to express rules and relationships relevant to a wide variety of settings
including manufacturing, drug discovery, manufacturing processes, health assistants, and
automated scientific discovery. In an example, translation module 358 receives a query from user system 320 whose contents include natural language of a request to identify alternate production processes for a particular production process. Translation module 358 processes the natural language contents of the query into a query that is in accordance with the language specified by the DSL.

Translation module 358 may use one or more models to generate graphs and representations of production processes in the query from user system 320. Translation module 358 may use a model, such as an LLM, to process the query into a JSON representation of productions steps within the production process. For example, translation module 358 may apply an LLM to a description of a production process included in a query to generate JSON representation triplets of each production process, where the JSON triplets are structured as “(Subject, Object, Relationship)”. Translation module 358 may use one or more components of analysis system 304 to vectorize the processed user query. For example, translation module 358 may provide each of the JSON triplets to an embedding model (e.g., embedding model 252 as illustrated in FIG. 2) and/or other component to vectorize the JSON triplets. Translation module 358 may generate the graph of the production process of the query as including one or more subgraphs, where each of the subgraphs corresponds to a portion of a production process.

In some examples, analysis system 204 may curate information from humans that includes data with text and associated triplets. Analysis system 204 may use information from descriptions of manufacturing steps and associated process flow diagram images. Analysis system 204 may convert images into the triplets.

When a query about manufacturing process is provided by the user, translation module 358 first converts the query to a Domain Specific Language (DSL). Analysis system 304 may create the DSL by using the examples that are retrieved by a Domain Finetuned Retrieval Model. Analysis system 304 may use the output to filter a Knowledge Base (e.g., contextual datastore 366) within RAG system 314 to make it relevant to the query and the retrieved context. Foundation model 354 may filter contextual datastore 366 of RAG system 314 to output representations (for example triplets of (Subject, Object, Relationship) in the case of KB but could be in other formats that captures the same information) that can be used to update and expand process store 312. The user can also perform inference and optimization on process store 312.

Analysis system 304 may use new metrics to measure similarities of statements in these DSLs based on domain specific sentence transformers that embed the underlying knowledge so that relevant information can be retrieved. Analysis system 304 may fine-tune domain specific sentence transformers with domain data such as process flows and their descriptions in manufacturing.

Analysis system 304 includes process store 312, which may be a software component of analysis system 304 configured to store information regarding production processes. In some examples, process store 312 is included in RAG system 314. Process store 312 may store information regarding production processes in a natural language and/or in the forms of graphs with natural language descriptions of production steps. In the example of FIG. 3, process store 312 includes production steps for the production of lithium carbonate, pure lithium, batteries, cellphone, electric vehicles (e.g., “EV”), metals, and electric motors with each of the production processes associated with other production processes. For example, process store 312 include entries with batteries shown as an input process to the production of EVs and lithium shown as an input process for the production of the batteries. In some examples, process store 312 includes a RAG system similar to RAG system 314.

Analysis system 304 includes contextual datastore 366, which may be a software component of analysis system 304 included in RAG system 314 and configured to store graphs of production process for use in comparison with a production process and/or production step(s) included in a query. Analysis system 304 may generate contextual datastore 366 based on information included in process store 312. In an example, analysis system 304 uses a model to generate JSON triplets for production steps within process store 312. Analysis system 304 vectorizes the JSON triplets and generates graphs of the production processes using the vectorized production steps that are represented by the JSON triplets. In some examples, contextual data store 366 is separate from RAG system 314.

Analysis system 304 may identify one or more subgraphs of contextual datastore that are isomorphic to a subgraph of the query. Analysis system 304 may use one or more isomorphic subgraph comparison techniques to identify subgraphs that are isomorphic to subgraphs of the graph representative of the production process of the received query. For example, analysis system 304 may identify a subgraph corresponding to productions steps within a production process that is isomorphic to a subgraph of productions steps within the graph of productions steps that make up the production process of the query. In some examples, analysis system 304 may identify one or more subgraphs of contextual datastore 366 that are isomorphic to a graph of a query, where the query includes only a subset of a production process. Analysis system 304 may use manufacturing process information to extract similarity between two chunks of texts. In general, analysis system 304 may provide a framework to find the similarity between the query and all the chunks in a manufacturing process corpus.

Analysis system 304 includes foundation model 354, which may be a ML model or other type of software component configured to process the identified graphs whose subgraphs are isomorphic to subgraphs of a queries production process. Foundation model 354 may process the identified graphs to generate natural language representations of the identified graphs and the graph of the query. As part of processing the graphs, foundation model 354 may convert the vectorized nodes of the graphs back into natural language and generate natural language explanations or summaries of the relationships between the production steps within the identified graph(s) and the production steps of the production process included in the query. In an example, analysis system 304 identifies a graph that includes subgraphs that are isomorphic to subgraphs of a graph derived from a query. Foundation model 354 processes the identified graph and the graph derived from the query to generate natural language of the production steps of the graphs and the relationships between the production steps.

In some examples, analysis system 304 may use foundation model 354 and/or other models to process descriptions of production processes. Analysis system 304 may apply the ML model to the description of the first production process into representations by generating statements based on the description of the production process that adhere to a modeling language and vectorizing the statements into the first node

In some examples, analysis system 304 may use the RAG included in process store 312 to constrain the output of foundation model 354. Analysis system 304 may generate prompts for foundation model 354 that include information from the RAG to constrain the output of foundation model 354 to production processes. For example, analysis system 304 may use “prompt stuffing” techniques to generate prompts that include: an identified graph, a graph derived from a query, and information regarding production process to constraint the output of foundation model 354 to production processes.

RAG systems may compute embeddings based on co-occurrences and retrieves the closest entry in the database based on distance metrics (typically RAG systems use cosine distance). RAG systems may be unable to impose immutable rules, capture semantic similarity, and is inefficient from a computational standpoint. Process store may require several examples to capture the underlying relationships due to an inability to handle rules. Analysis system 304 may add examples to the input prompt of the LLM and ensure that the example lengths are below the max context size supported by the Large Language Model (LLM) (128K token size on some LLMs). The limitations of an LLM may impede the use of complex relationships. Process store 312 may use a DSL to express rules and relationships relevant to a wide variety of settings including manufacturing, drug discovery, manufacturing processes, health assistants, and automated scientific discovery. Process store 312 may use metrics and embeddings that capture the similarity of statements in DSL that correlate with their semantic similarity. Analysis system 304 may use LLMs to reason on input data to find the fundamental rules relevant to the query along abductive and deductive reasoning to reach appropriate conclusions relevant to the query. Analysis system 304 may use conclusions coupled to the traditional RAG system to respond to a user query. For instance, analysis system 304 may use the following novelties: 1) Use of DSLs to capture universal rules in the RAG framework 2) New metrics to measure similarities of statements in these DSLs 3) Use of LLM based reasoning to derive relevant conclusions from retrieved rules related to a query 4) Augmenting existing RAG systems with LLM derived abductive and deductive conclusions.

Analysis system 304 includes assistant 358, which may be a software component of analysis system 304 configured to output information regarding alternate production processes. Analysis system 304 may provide the output of foundation model 354 to assistant 358 for assistant 358 to process and generate constrained optimization output 362, which may be a natural language output that includes one or more recommendations. For example, analysis system 304 may generate constrained optimization output 362 as including recommendations to swap production processes and/or which production processes may be performed with equipment/facilities associated with a particular production process. In some examples, analysis system 304 may use risk-averse optimization of a stochastic optimization representation to discover undiscovered production capacity. Analysis system 304 may output indications of production processes where a first production process (e.g., an input production process) is of a first area of application (e.g., a field of production, manufacturing, and/or other domain) and the second production process (e.g., an output production process) is of a second area of application (e.g., a different field of production, manufacturing, or other domain compared to the first production process).

Foundation model 354 generate output for inclusion in process store 312 as knowledge base output 364. Knowledge base output 364 may include information from the query and the identification of alternate production processes that analysis system 304 uses to update and/or expand process store 312. For example, analysis system 304 may update process store 312 to include information regarding a production process from a query and alternate production processes related to the production process from the query.

Analysis system 304 may obtain information from one or more of external sources 324 for inclusion in process store 312. As illustrated in FIG. 3, analysis system 304 may obtain information from external sources that includes PDFs, spreadsheets, datastores, reports, and/or other sources of information. Analysis system 304 may obtain information regarding production processes from external sources 324 and process the information into graphs and other forms for inclusion in process store 312. While companies may refrain from sharing proprietary data on manufacturing, procurement, and supply chains, analysis system 304 may obtain manufacturing steps for various systems that are publicly available in publications, patents, and online sources. In some examples, analysis system 304 may obtain information from external sources 324 that include defense agency databases on transportation to identify sources and suppliers of various items. In addition, analysis system 304 may construct knowledge-based models using public, government, and private information.

Analysis system 304 may perform one or more functions regarding production processes. Analysis system 304 may discover production and processing capability in a national industrial base using generative AI, scalable optimization, and AI reasoning. Analysis system 304 may enable repurposing of supply chain infrastructure to rapidly respond to critical problems. For example, analysis system 304 may identify alternate production processes for manufacturing of hand sanitizer, face shields, masks during pandemics, identify capabilities to rapidly make parts for a tank, ammunition, drone components, etc. during wartime and/or other capabilities. As part of performing the one or more functions, analysis system 304 may capture knowledge for manufacturing: processes, raw materials, equipment for items and extract similar steps, inputs (ingredients), and equipment.

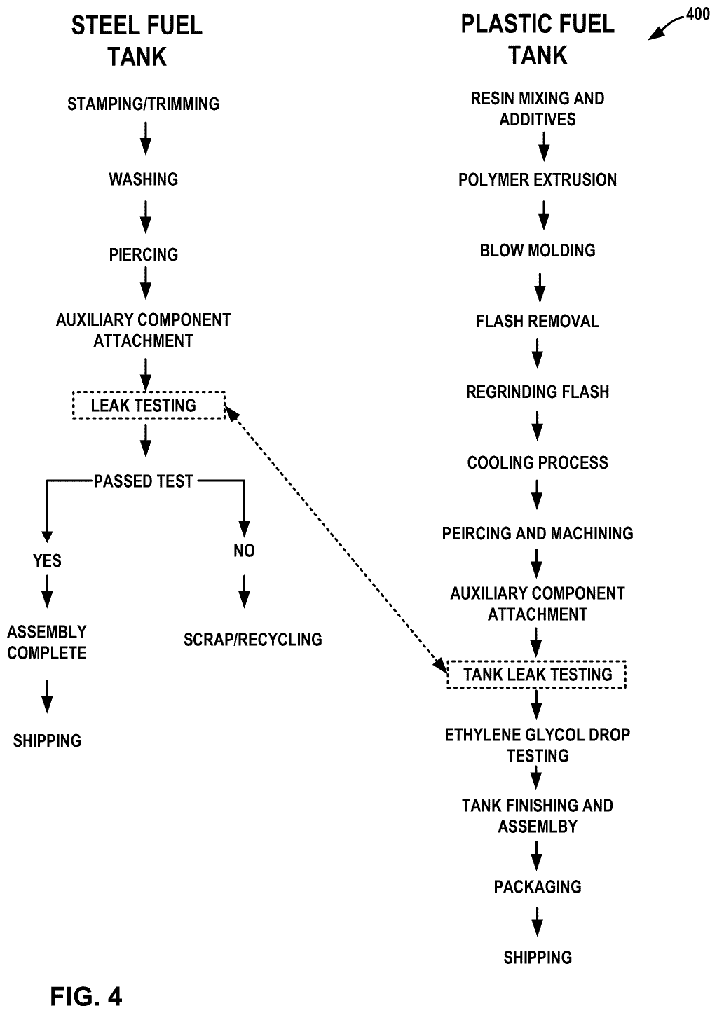

FIG. 4 is an example set 400 of production processes, in accordance with techniques of the disclosure. FIG. 4 is described in the context of FIG. 1.

Analysis system 104 may identify alternate production steps between production processes. In the example of FIG. 4, analysis system 104 identifies alternate production steps between a production process for a steel fuel tank and a production process for a plastic fuel tank. While having different names (“LEAK TESTING” and “TANK LEAK TESTING”), analysis system 104 identifies the two production processes as being alternate.

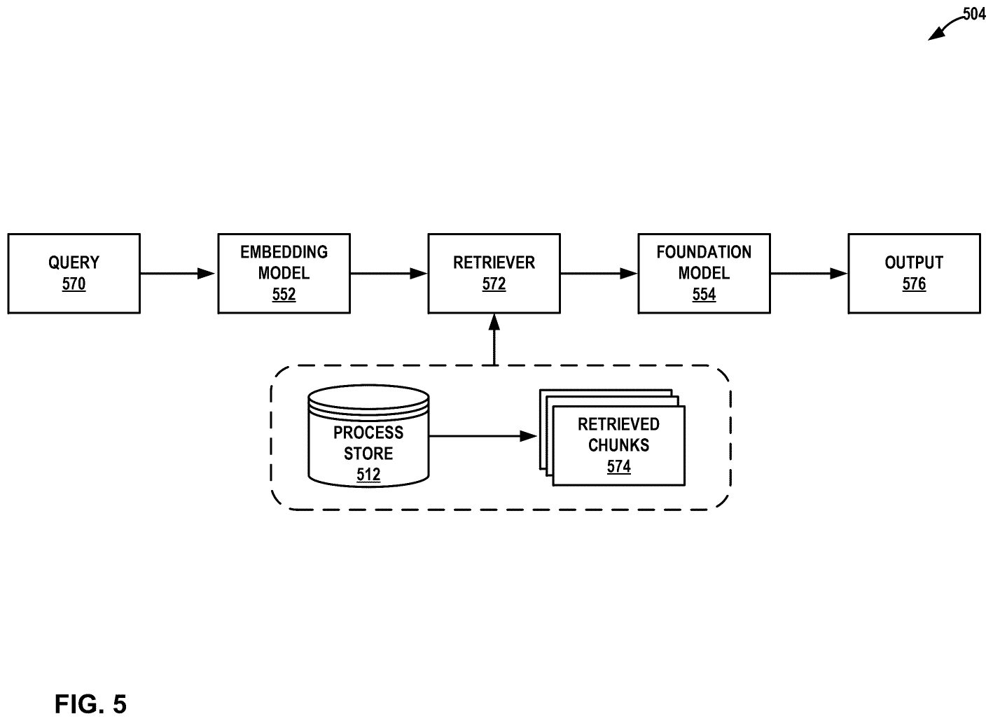

FIG. 5 is an example configuration of an analysis system 504, in accordance with techniques of the disclosure. Analysis system 504 may be an instance of analysis system 104 as illustrated in FIG. 1.

Analysis system 504 may finetune a large language model to generate structured outputs for input manufacturing queries. For example, embedding model 552 may output JSON representation of all triplets (Subject, Object, Relationship) for any given text. Embedding model 552 enable analysis system 504 to identify the information in process store 512 that is relevant for the query and associated areas. Embedding model 552 may generate a score for all the information chunks which can then be filtered. In addition, analysis system 504 may use constrained decoding to make sure the output of foundation module 554 follows these rules. In an example, analysis system 504 receives query 570 regarding a production process. Embedding module 552 generates an embedding of the contents of query 570 and causes retriever 572 to retrieve chunks from knowledge base. In some examples, embedding model 552 may perform a comparison to identify alternative steps for manufacturing.

Retriever 572 may be a software component of analysis system 504 configured to retrieve information for processing. Retriever 572 may retrieve chunks derived from process store 512. Retrieved chunks 574 may include chunks of file contents (e.g., subsections of the contents) stored in process store 512 and that include information regarding production processes. Retriever 574 may convert an input query into a JSON triplet and compare text chunks that have been processed into representations. Retriever 574 may enable analysis system 504 to identify information in process store 512 that is relevant for a query. In some examples, retrieved chunks 574 may include information maintained by a RAG system for use in constraining the output of one or more models.

Foundation model 554 may process the embedding query and retrieved chunks 574. In some examples, analysis system 504 may include retrieved chunks 574 in a prompt provided to foundation model 554 as a form of prompt stuffing to constrain the output of foundation model 554. Foundation model 554 may generate output 576 based on the embedding query and retrieved chunks 574. For example, foundation model 554 may generate output 576 as including natural language description of alternate production processes. In some examples, analysis system 504 may use optimization algorithms to identify ideal candidates for repurposing the supply network based on cost, schedule, capacity, and benefit among other factors.

Analysis system 504 may use generative machine learning methods/techniques to perform one or more functions. Analysis system 504 may perform knowledge extraction from public, government (e.g., military), and private sources, continuously monitor the state of supply chain(s), and/or generate models in new supply network domain specification language. As part of using the generative machine learning methods/techniques, analysis system 504 may discover undiscovered production capabilities in an industrial base.

In some examples, analysis system 504 may use artificial intelligence reasoning to represent one or more steps of a production process and/or supply chain. Analysis system 504 may use the artificial intelligence reasoning to represent manufacturing capabilities, raw materials and associated grade, transportation capabilities, science and processes for transforming materials from one form to another, etc. As part of using the artificial intelligence reasoning, analysis system 504 may support queries such repurposing suppliers for accommodate increase in demand, disruption in suppliers, raw materials, labor issues, etc.

In some examples, analysis system 504 may use a pre-trained LLM (e.g., a pretrained instance of foundation model 554) to analyze text of a production process. Foundation model 554 or another generative AI model may parse text and learns ontology and process flow for the manufacturing of multiple systems. The Generative AI/Optimization model may find common steps and processes and may obtain information from a supplier database on capabilities, from manufacturing agreements with government agencies, manufacturing intelligence and integration sources, and/or other sources. The AI model may use AI reasoning to convert flow diagrams to optimization problems in one or more ways, such as by using neuro-symbolic reasoning, logic programming, and/or probabilistic programming. The AI model may perform graph structure discovery for computing replaceable steps in production using one or more techniques, such as subgraph isomorphism algorithms (e.g., branch and bound, cutting plane etc.), community detection algorithm, and/or graph matching methods.

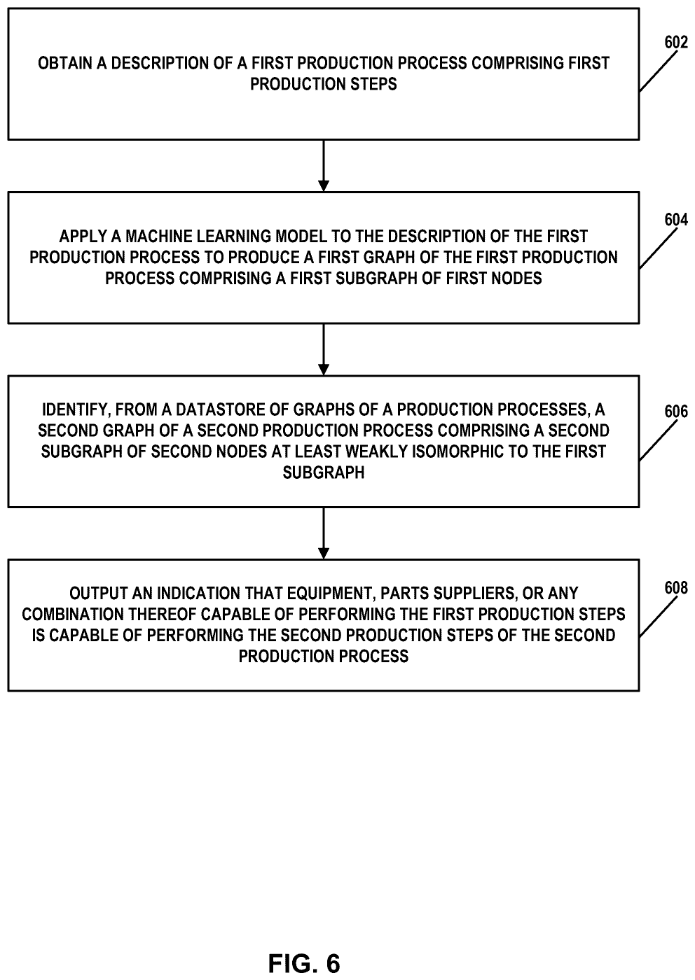

FIG. 6 is a flowchart illustrating an example operation to identify alternate production processes, in accordance with the techniques of this disclosure. FIG. 6 is described in the context of FIG. 1 for convenience.

A computing system, such as analysis system 104, obtains a description of a first production process comprising first production steps (602). Analysis system 104 may obtain the description of the first production process as a query received from a user system, such as user system 120. For example, analysis system 104 may obtain a description of a first production process as part of a query from a user requesting the identification of alternate production processes.

Analysis system 104 applies a machine learning (ML) model to the description of the first production process to produce a first graph of the first production process comprising a first subgraph of first nodes (604). Analysis system 104 may produce the first graph with each of the first nodes representing a corresponding first production step of the first production steps. As part of producing the first graph, analysis system 104 may translate the description of the first production process into a DSL. Analysis system 104 may use the ML to generate JSON triplets representative of each production step and vectorize each of the production step into nodes of the first graph.

Analysis system 104 identifies, from a datastore for graphs of a production process, such as RAG system 114, a second graph of a second production process comprising a second subgraph of second nodes at least weakly isomorphic to the first subgraph (606). Analysis system 104 may identify a second graph that includes second nodes, where each second node of the second nodes represents a corresponding second production step of second production steps of the second production process. Analysis system 104 may compare edges of graphs in addition to or in lieu of comparing nodes of the graphs. In an example, analysis system 104 applies a subgraph isomorphism algorithm to identify the second subgraph that is at least weakly isomorphic to the first subgraph.

Analysis system 104 outputs an indication that equipment, parts, suppliers, or any combination thereof capable of performing the first production steps is capable of performing the second production steps of the second production process (608). Analysis system 104 may output the indication based on the identified second graph. In an example, analysis system 104 identifies a second graph that includes a subgraph isomorphic to the first graph. Based on the identification of the second graph, analysis system 104 generates the indication as including a natural language description of the second production process. Analysis system 104 may output an indication of the second production process, where the second production process is in a second field of industry and the first production process is in a first field of industry. For example, analysis system 104 may output an indication of a second production process that is in a field of industry associated with chemical production in response to receiving an input graph regarding a first production process that is in a field of industry associated with applications of chemicals to products. A “field of industry” as described herein refers to a particular area of industry, manufacturing, production, or engineering, in which similar or related products are manufactured or processes are performed by enterprises that operate in a similar or shared economic sector. Typically, processes, knowledge, or expertise within a particular field of industry may be recognized amongst operators within that field as having applicability or relevance to operations within that field of industry. However, processes, knowledge, or expertise within a first field of industry it may be less commonly recognized as applicable or relevant to a second field of industry.

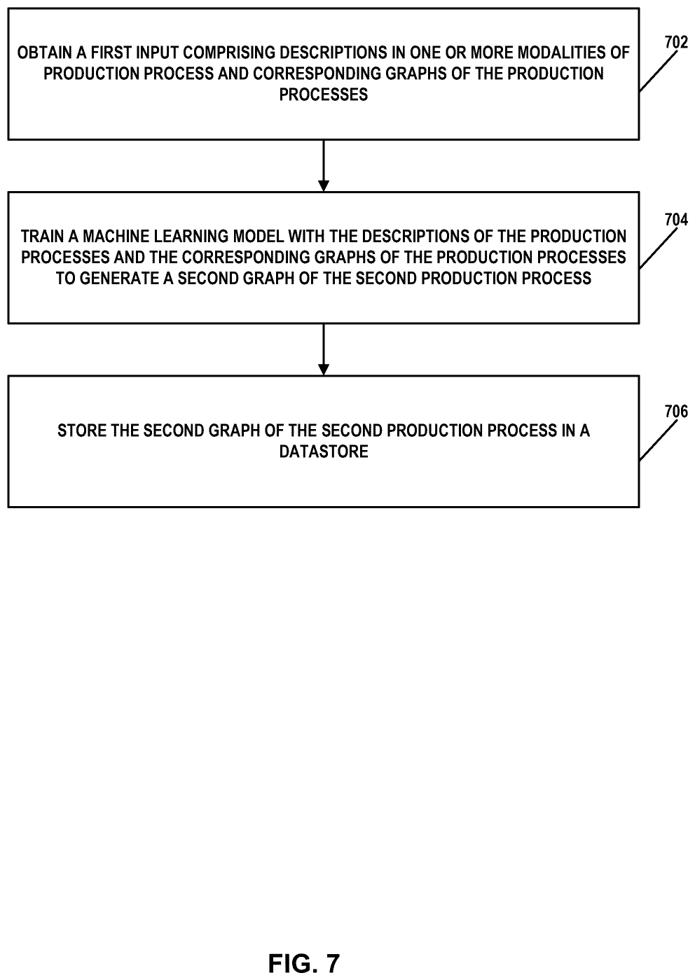

FIG. 7 is a flowchart illustrated an example operation to train a machine learning model, in accordance with the techniques of this disclosure. FIG. 7 is described in the context of FIG. 1 for convenience.

A computing system, such as analysis system 104, obtains a first input comprising descriptions in one or more modalities of production processes and corresponding graphs of the production processes (702). Analysis system 104 may obtain input from a user, such as a subject matter expert that includes productions process and corresponding graphs. Analysis system 104 may use multi-modal descriptions and corresponding graphs as “known good” or “known correct” graphs that are based on the descriptions in one or more modalities of the production processes.

Analysis system 104 trains a machine learning (ML) model with the descriptions of the production processes and the corresponding graphs of the production processes to generate a second graph of the second production process (704). Analysis system 104 may generate the second graph of the second production process from a second input comprising a natural language description of a second production process. Based on an output of the machine learning model, analysis system 104 may automatically adjust one or more weights of the model. In some examples, analysis system 104 may train one or more AI agents included in a multi-agentic architecture of analysis system 104.

Analysis system 104 stores the second graph of the second production process in a datastore, such as RAG system 114 (706). Analysis system 104 may store the second graph in RAG system 114 based on determining that the ML model has reached one or more performance or accuracy thresholds. Analysis system 104 may use the trained ML model process additional descriptions of production process for inclusion in RAG system 114 as graphs.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A computing system for identifying production processes having similar production steps as a first production process, the computing system comprising:
storage media storing graphs of production processes; and
processing circuitry in communication with the storage media and configured to:
obtain a description of the first production process comprising first production steps;
apply a machine learning (ML) model to the description of the first production process to produce a first graph of the first production process comprising a first subgraph of first nodes, wherein each first node of the first nodes represents a corresponding first production step of the first production steps;
identify, from the storage media, a second graph of a second production process comprising a second subgraph of second nodes isomorphic to the first subgraph, wherein each second node of the second nodes represents a corresponding second production step of second production steps of the second production process; and
based on the identified second graph, output an indication that equipment, parts, suppliers, or any combination thereof capable of performing the first production steps is capable of performing the second production steps of the second production process.

2. The computing system of claim 1, wherein the processing circuitry is further configured to:
process, using a language model, the identified second graph into natural language text that includes the indication that equipment capable of performing the first production steps is capable of performing the second production steps of the second production process.

3. The computing system of claim 1, wherein the first production process is of a first field of industry and the second production process is of a second field of industry.

4. The computing system of claim 1, wherein to apply the ML model to the description of the first production process into representations, the processing circuitry is further configured to:
generate statements based on the description of the production process that adhere to a modeling language; and
vectorize the statements into the first nodes.

5. The computing system of claim 4, wherein the modeling language is a domain specific language specific to a production process domain.

6. The computing system of claim 1, wherein the datastore includes a retrieval augmented generation (RAG) database, and wherein to identify the second graph, the processing circuitry is further configured to:
determine a plurality of scores, each score of the plurality of scores representative of a distance between first nodes and the second nodes node or a distance between a description of an edge in two graphs, or both; and
determine whether each score of the plurality of scores satisfies a predetermined threshold.

7. The computing system of claim 6, wherein to compare the representations to a plurality of graphs, the processing circuitry is further configured to:
apply an optimizer algorithm to determine the distance between the representations of subgraphs within the first graph and representations of subgraphs within the second graph associated between each of the representations representative of the production steps within the production process and one or more representations representative of production processes included in the plurality of graphs of the RAG database.

8. The computing system of claim 6, wherein the processing circuitry is further configured to:
obtain information regarding the production processes; and
generate a corresponding graph of the graphs from the datastore, wherein to generate the corresponding graph, the processing circuitry is further configured to, for each production process:
parse one or more second manufacturing steps from the second manufacturing processes; and
vectorize the one or more second manufacturing steps into a node of the RAG database.

9. The computing system of claim 6, wherein to apply the optimizer algorithm, the processing circuitry is further configured to apply at least one of:
a genetic algorithm;
simulated annealing;
Monte Carlo tree search; or
a tree search.

10. The computing system of claim 6, wherein the processing circuitry is further configured to:
obtain one or more graphs of the plurality of graphs from a human.

11. The computing device of claim 1, wherein to output the indication, the processing circuitry is further configured to output a recommendation to configure the equipment to perform the second production steps.

12. The computing device of claim 1, wherein the processing circuitry is further configured to:
based on the identification of the second graph, determine a potential product of the second production process; and
output a report that includes an indication of the potential product.

13. A method for identifying production processes having similar production steps as a first production process, the method comprising:
obtaining, by processing circuitry of a computing system, a description of the first production process comprising first production steps;
applying, by the processing circuitry, a machine learning (ML) model to the description of the first production process to produce a first graph of the first production process comprising a first subgraph of first nodes, wherein each first node of the first nodes represents a corresponding first production step of the first production steps;
identifying, by the processing circuitry, from a datastore of graphs of production processes, a second graph of a second production process comprising a second subgraph of second nodes isomorphic to the first subgraph, wherein each second node of the second nodes represents a corresponding second production step of second production steps of the second production process; and
based on the identified second graph, outputting, by the processing circuitry, an indication that equipment, parts, suppliers, or any combination thereof capable of performing the first production steps is capable of performing the second production steps of the second production process.

14. The method of claim 13, further comprising:
processing, by the processing circuitry and using a language model, the identified second graph into natural language text that includes the indication that equipment capable of performing the first production steps is capable of performing the second production steps of the second production process.

15. The method of claim 13, wherein the first production process is of a first field of industry and the second production process is of a second field of industry.

16. The method of claim 13, wherein applying the ML model to the description of the first production process into representations further comprises:
generating statements based on the description of the production process that adhere to a modeling language; and
vectorizing the statements into the first nodes.

17. The method of claim 16, wherein the modeling language is a domain specific language specific to a production process domain.

18. The method of claim 13, wherein the datastore includes a retrieval augmented generation (RAG) database, and wherein identifying a second graph further comprises:
determining a plurality of scores, each score of the plurality of scores representative of a distance between first nodes and the second nodes node or a distance between a description of an edge in two graphs, or both; and
determining whether each score of the plurality of scores satisfies a predetermined threshold.

19. The method of claim 18, wherein comparing the representations to a plurality of graphs further comprises:
applying an optimizer algorithm to determine the distance between the representations of subgraphs within the first graph and representations of subgraphs within the second graph associated between each of the representations representative of the production steps within the production process and one or more representations representative of production processes included in the plurality of graphs of the RAG database.

20. A method comprising:
obtaining, by processing circuitry of a computing system, a first input comprising descriptions in one or more modalities of production processes and corresponding graphs of the production processes;
training, by the processing circuitry, a machine learning (ML) model with the descriptions of the production processes and the corresponding graphs of the production processes to generate, from a second input comprising a natural language description of a second production process, a second graph of the second production process; and
storing, by the processing circuitry, the second graph of the second production process in a datastore.
